(19) United States
(12) Patent Application Publication
(10) Pub. No.: US 2026/0319811 A1
(43) Pub. Date: Oct. 15, 2026

(54) MERGING CONFIGURATIONS OF FRONTEND MICROSERVICES DEFINING PORTIONS OF A USER INTERFACE OF A WEB APPLICATION

(71) Applicant: Dell Products L.P., Round Rock, TX (US)

(72) Inventors: Artur Romov, Netanya (IL); Dmitry Brusilovsky, Haifa (IL); Muhammad Dahamshi, Kafar Kanna (IL); Idan Cohen, Haifa (IL); Michael Malashko, Rehovot (IL)

(21) Appl. No.: 19/178,285

(22) Filed: Apr. 14, 2025

(51) Int. Cl. G06F 9/445; G06F 3/0482

(52) U.S. Cl. CPC G06F 9/44505; G06F 3/0482

(57) ABSTRACT

An apparatus comprises at least one processing device configured to determine configuration information for two or more frontend microservices, the two or more frontend microservices defining two or more different portions of a user interface of a web application. The at least one processing device is also configured to generate a merged configuration, the merged configuration comprising a configuration map merging the configuration information for the two or more frontend microservices. The at least one processing device is further configured to provide the merged configuration for the two or more frontend microservices for mounting in a core shell of the web application running on a client device for rendering of the two or more different portions of the user interface of the web application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Web applications, also referred to as web apps, are application programs designed for delivery to users over a network, such as the Internet, through a browser interface. For example, web applications include client server computer programs in which the client runs in a web browser and the web application is hosted in the server. Web applications may include web services and other website components that perform functions for users. Various software frameworks may be used to provide web applications. Such software frameworks, also referred to as web frameworks or web application frameworks, facilitate the building and deployment of web applications. For example, web application frameworks can provide common libraries for various application functions and promote code re-use.

### SUMMARY

Illustrative embodiments of the present disclosure provide techniques for merging configurations of frontend microservices defining portions of a user interface of a web application.

In one embodiment, an apparatus comprises at least one processing device comprising a processor coupled to a memory. The at least one processing device is configured to determine configuration information for two or more frontend microservices, the two or more frontend microservices defining two or more different portions of a user interface of a web application. The at least one processing device is also configured to generate a merged configuration, the merged configuration comprising a configuration map merging the configuration information for the two or more frontend microservices. The at least one processing device is further configured to provide the merged configuration for the two or more frontend microservices for mounting in a core shell of the web application running on a client device for rendering of the two or more different portions of the user interface of the web application.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for merging configurations of frontend microservices defining portions of a user interface of a web application in an illustrative embodiment.

FIG. 2 is a flow diagram of an exemplary process for merging configurations of frontend microservices defining portions of a user interface of a web application in an illustrative embodiment.

FIG. 3 shows a system configured for distributed auto-configuration of a micro-frontend application environment in an illustrative embodiment.

FIG. 4 shows another system configured for distributed auto-configuration of a micro-frontend application environment in an illustrative embodiment.

FIG. 5 shows pseudocode of a micro-frontend configuration in an illustrative embodiment.

FIGS. 6A and 6B show pseudocode of a unified micro-frontend configuration for distributed micro-frontend services in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

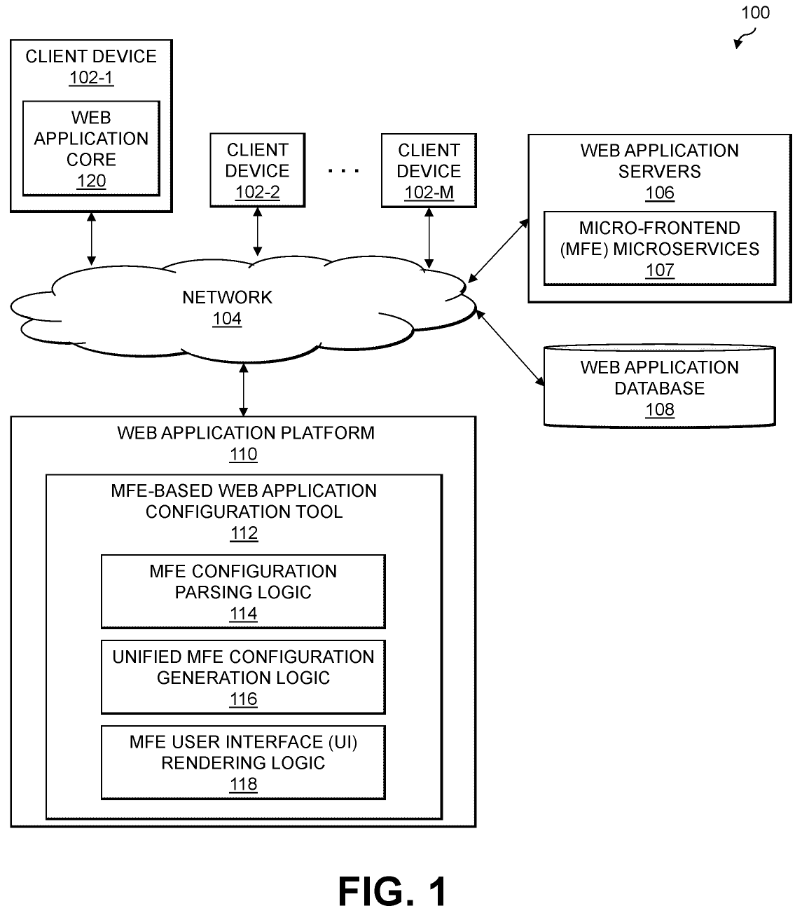

FIG. 1 shows an information processing system 100 configured in accordance with an illustrative embodiment. The information processing system 100 is assumed to be built on at least one processing platform and provides functionality for merging configurations of frontend microservices defining portions of a user interface (UI) of a web application. The information processing system 100 includes a set of client devices 102-1, 102-2, . . . 102-M (collectively, client devices 102) which are coupled to a network 104. Also coupled to the network 104 is one or more web application servers 106 hosting micro-frontend (MFE) microservices 107, a web application database 108, and a web application platform 110. The web application database 108 is configured to store portions of web applications (e.g., MFE configurations) for web applications that are served to the client devices 102 using web application platform 110.

Each of the client devices 102 is assumed to run a web browser utilized to access one or more web applications that utilize MFE microservices 107 hosted by the web application servers 106. For example, client device 102-1 is assumed to access a web application whose graphical user interface (GUI) is rendered using one or more MFEs that are provided by the MFE microservices 107 hosted by the web application servers 106. As discussed above, web applications may be implemented as application programs designed for delivery to users over a network (e.g., network 104) through a browser interface. The web application may be implemented as a client-server computer program, in which the client runs in a web browser on the client device 102-1 while the application provided using web application platform 110 and the MFE microservices 107 hosted by the web application servers 106.

A web application may be formed from multiple portions or modules, such as different portions of a GUI that are provided via different ones of the MFE microservices 107 hosted by the web application servers 106. In a MFE web application architecture, for example, each MFE provides an independently deployable fronted module of a web application that can be served to the client devices 102. A particular web application portion or web application module may include one or more pages of the web application, one or more sections of one or more pages of the web application, a set of features of one or more sections or one or more pages of the web application, etc. The web application servers 106 are entities that serve application code for web applications to the client devices 102, e.g., via the MFE microservices 107 that are rendered together in browsers of the client devices 102 “on demand.” The client device 102-1, for example, runs a web application core 120 (also referred to as an application core or application shell) which dynamically fetches web application portions or modules (e.g., from the web application servers 106). This is illustratively done via or utilizing the web application platform 110 implementing a MFE-based web application configuration tool 112 providing an application programming interface (API) for obtaining a single unified configuration for multiple MFEs (e.g., through processing and merging distributed configurations of MFEs provided by the MFE microservices 107 of the web application servers 106, including monitoring of configuration changes and dynamic reconciliation) for auto-updating of a GUI composite web application that is served to the client devices 102. The web application core 120 on the client device 102-1 assembles the web application portions or modules into the final web application that the user of the client device 102-1 sees. Although not shown in FIG. 1 for clarity of illustration, the client devices 102-2 through 102-M are assumed to implement respective web application cores configured to provide functionality similar to that of the web application core 120.

Web application portion or web application module metadata refers to the configuration that each web application portion or web application module provides. The web application portion or web application module metadata may include or contain everything that the web application core 120 needs to perform its associated functions.

The client devices 102 may comprise, for example, physical computing devices such as Internet of Things (IoT) devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as virtual machines (VMs), containers, etc.

The client devices 102 in some embodiments comprise respective computers associated with a particular company, organization or other enterprise. At least portions of the system 100 may thus be referred to herein as collectively comprising an “enterprise.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The web application database 108, as discussed above, is configured to store and record information relating to web applications. Such information may include, but is not limited to, information relating to the different web application portions or modules of one or more web applications (e.g., MFEs provided by MFE microservices 107 of the web application servers 106), including configurations thereof, “unified” or merged MFE configurations generated by the MFE-based web application configuration tool 112, etc. The web application database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the web application platform 110, as well as to support communication between the web application platform 110 and other related systems and devices not explicitly shown.

The web application platform 110 may be provided as a cloud service that is accessible by one or more of the client devices 102 to allow users thereof to perform rendering of web applications. In some embodiments, the client devices 102 are utilized by members of the same enterprise, organization or other entity that operates the web application platform 110. In other embodiments, the client devices 102 are utilized by members of one or more enterprises, organizations or other entities different than the enterprise, organization or other entity that operates the web application platform 110 (e.g., a first enterprise provides support functionality for multiple different customers, businesses, etc.). Various other examples are possible.

The client devices 102, the web application servers 106 and the web application platform 110 in the FIG. 1 embodiment are assumed to be implemented using at least one processing device. Each such processing device generally comprises at least one processor and an associated memory and implements one or more functional modules for controlling certain features of the client devices 102, the web application servers 106 and the web application platform 110. In the FIG. 1 embodiment, for example, the web application core 120 of the client device 102-1 implements functionality for fetching web application portions or modules (e.g., MFEs provided by MFE microservices 107 of the web application servers 106), and for rendering such web application portions of modules to provide a GUI of a web application. To do so, the web application core 120 may interact with the web application platform 110 as described in further detail below.

The web application core 120 on client device 102-1 is configured to receive, from a user, a request to execute a web application that utilizes a plurality of web application portions or modules configured for loading into the web application independent of one another. The web application core 120 is configured to send queries to the web application servers 106 (e.g., MFE microservices 107 thereof) for data and metadata associated with the plurality of web application portions of modules utilized by the web application executed on the client device 102-1 (e.g., dynamically and on demand as a user navigates a GUI of the web application). The web application core 120 generates the GUI of the web application that a user of the client device 102-1 sees by loading instances of the web application portions or modules at specified locations in one or more pages of the web application.

The web application portions or modules (e.g., MFEs) that are used by the web application may be rendered on demand by the web application core 120 of the client device 102-1. A MFE environment typically requires an onboarding mechanism for each MFE, which in conventional approaches requires hard-coded prerequisites in the web application core 120 (e.g., a core shell application) even when dynamic web application portion or module loading is used. The web application platform 110 comprises MFE-based web application configuration tool 112, which is configured for distributed autoconfiguration of MFEs of the MFE microservices 107 hosted by the web application servers 106. This includes providing an API for a generic MFE configuration that enables dynamic injection of distributed MFEs into a unified ecosystem of the web application core 120 while avoiding hard-coded paths for each of the distributed MFEs. The MFE-based web application configuration tool 112 comprises MFE configuration parsing logic 114, unified MFE configuration generation logic 116 and MFE UI rendering logic 118. The MFE configuration parsing logic 114 is configured to parse and process distributed MFE configurations (e.g., for different MFEs provided by MFE microservices 107 running on the web application servers 106). The unified MFE configuration generation logic 116 is configured to generate a single unified MFE configuration through automated merging of the different distributed MFE configurations (e.g., including monitoring for MFE configuration changes, dynamic reconciliation of configuration changes and updates, etc.). The MFE UI rending logic 118 is configured to provide the unified MFE configuration to the web application core 120, such as via mounting the unified MFE configuration (e.g., an MFE configuration mapping or MFE configuration map) to a composite UI container as a file that is made available via a HyperText Transfer Protocol (HTTP) request. The web application core 120 will consume and read the unified MFE configuration, parse it, and render the distributed MFEs in a proper layout according to their respective activation conditions as a user of the client device 102-1 uses the web application.

It is to be appreciated that the particular arrangement of the client devices 102, the web application servers 106, the web application database 108 and the web application platform 110 illustrated in the FIG. 1 embodiment is presented by way of example only, and alternative arrangements can be used in other embodiments. In some embodiments, for example, the web application database 108 may be implemented at least in part internal to the web application servers 106. As another example, at least a portion of the functionality associated with the web application platform 110 (e.g., the MFE-based web application configuration tool 112, or parts or portions thereof such as the MFE configuration parsing logic 114, the unified MFE configuration generation logic 116 and/or the MFE UI rendering logic 118) may be implemented at least in part by one or more of the client devices 102 (e.g., as part of web application core 120) and/or by one or more of the web application servers 106.

At least portions of the MFE microservices 107, the MFE-based web application configuration tool 112, the MFE configuration parsing logic 114, the unified MFE configuration generation logic 116, the MFE UI rendering logic 118 and the web application core 120 may be implemented at least in part in the form of software that is stored in memory and executed by a processor.

The client devices 102, the web application servers 106, the web application database 108, the web application platform 110 and other portions of the system 100 may be part of cloud infrastructure as will be described in further detail below.

The client devices 102, the web application servers 106, the web application database 108, the web application platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, memory, storage and network resources.

The client devices 102, the web application servers 106, the web application database 108, the web application platform 110 or components thereof, may be implemented on respective distinct processing platforms, although numerous other arrangements are possible. For example, in some embodiments at least portions of the web application servers 106, the web application database 108 and the web application platform 110 are implemented on the same processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the client devices 102, the web application servers 106, the web application database 108 and the web application platform 110, or portions or components thereof, to reside in different data centers. Numerous other distributed implementations are possible. The client devices 102, the web application servers 106, the web application database 108 and the web application platform 110 or portions thereof can also be implemented in a distributed manner across multiple data centers.

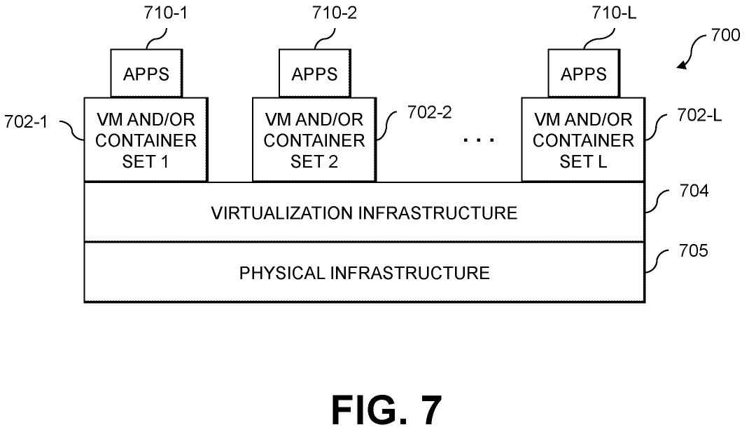

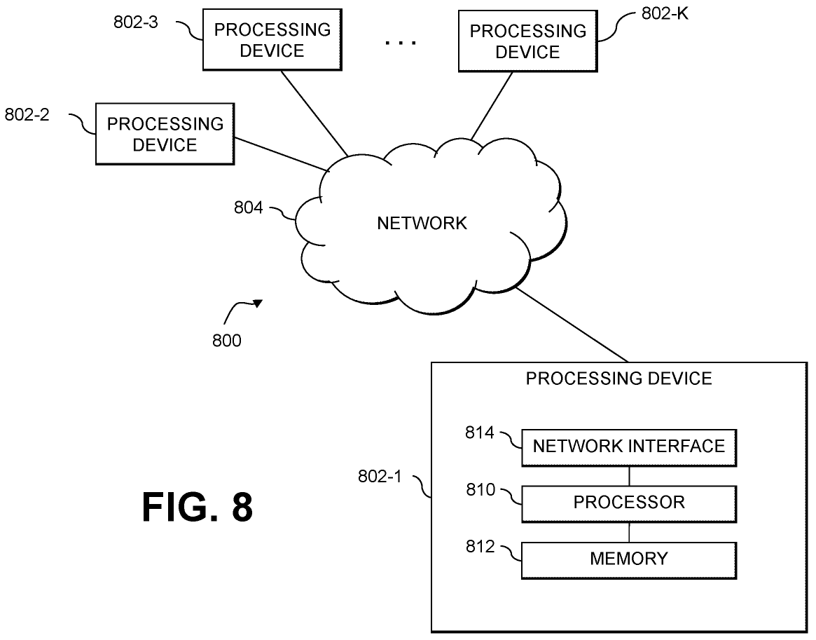

Additional examples of processing platforms utilized to implement the web application platform 110 and other components of the information processing system 100 in illustrative embodiments will be described in more detail below in conjunction with FIGS. 7 and 8.

It is to be understood that the particular set of elements shown in FIG. 1 for merging configurations of frontend microservices defining portions of a UI of a web application is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

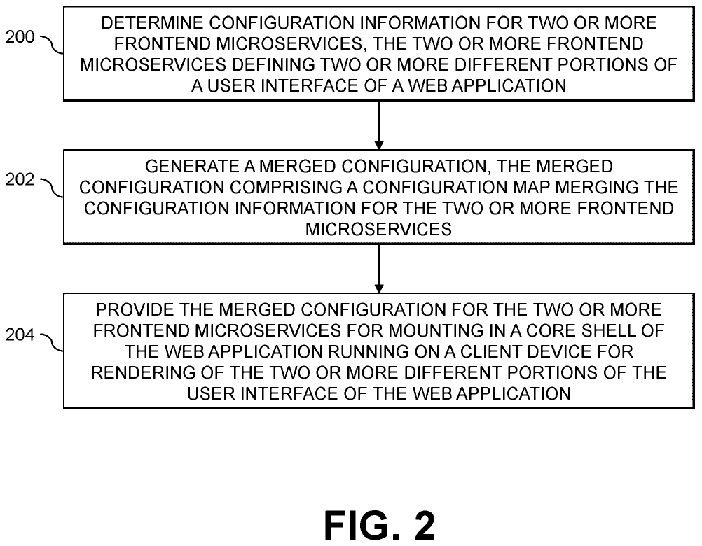

An exemplary process for merging configurations of frontend microservices defining portions of a UI of a web application will now be described in more detail with reference to the flow diagram of FIG. 2. It is to be understood that this particular process is only an example, and that additional or alternative processes for merging configurations of frontend microservices defining portions of a UI of a web application may be used in other embodiments.

In this embodiment, the process includes steps 200 through 204. These steps are assumed to be performed by the client devices 102, the web applications servers and/or the web application platform 110 utilizing the MFE-based web application configuration tool 112, the MFE configuration parsing logic 114, the unified MFE configuration generation logic 116, the MFE UI rendering logic 118 and the web application core 120. The process begins with step 200, determining configuration information for two or more frontend microservices, the two or more frontend microservices defining two or more different portions of a UI of a web application. The two or more frontend microservices may comprise independently deployable MFEs for the UI of the web application. The configuration information for a given one of the two or more frontend microservices may specify: one or more activation conditions for rendering a given portion of the UI of the web application; a layout configuration for rendering a given portion of the UI of the web application; navigation menu items for rendering a given portion of the UI of the web application; settings page configurations for rendering a given portion of the UI of the web application; etc. A first one of the two or more frontend microservices may utilize a first web application framework and at least a second one of the two or more frontend microservices may utilize a second web application framework, the second web application framework being different than the first web application framework.

In step 202, a merged configuration is generated. The merged configuration comprises a configuration map merging the configuration information for the two or more frontend microservices. Generating the merged configuration may comprise at least one of grouping and sorting of navigation items of the two or more different portions of the UI of the web application. Generating the merged configuration may also or alternatively comprise resolving one or more conflicts between a first portion of the configuration information for a first one of the two or more frontend microservices and at least a second portion of the configuration information for a second one of the two or more frontend microservices. The merged configuration may specify locations of code bundles for the two or more frontend microservices.

In step 204, the merged configuration for the two or more frontend microservices is provided for mounting in a core shell of the web application running on a client device for rendering of the two or more different portions of the UI of the web application. Providing the merged configuration for the two or more frontend microservices for mounting in the core shell of the web application running on the client device may comprise providing the merged configuration for mounting to a designated hard-coded prerequisite in the core shell of the web application. Providing the merged configuration for the two or more frontend microservices for mounting in the core shell of the web application running on the client device may also or alternatively comprise providing the merged configuration as a volume for mounting in the core shell of the web application.

The FIG. 2 process may further include monitoring for one or more changes in the configuration information for the two or more frontend microservices, dynamically updating the merged configuration for the two or more frontend microservices based at least in part on the monitored one or more changes in the configuration information for the two or more frontend microservices, and re-mounting the dynamically updated merged configuration for the two or more frontend microservices in the core shell of the web application running on the client device for real-time updating of the rendering of the two or more different portions of the UI of the web application. The one or more changes in the configuration information for the two or more frontend microservices may comprise real-time onboarding one or more additional frontend microservices. The one or more changes in the configuration information for the two or more frontend microservices may also or alternatively comprise real-time offboarding of at least one of the two or more frontend microservices.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Large and complex frontend application development projects may utilize a microservice architecture, which decomposes a web application into smaller, independently deployable frontend modules. These modules may have their own continuous integration (CI) build pipelines, enabling teams to work autonomously. The different modules are rendered together in the browser “on demand” using various techniques. This approach is called MFE composition. An MFE environment requires an onboarding mechanism for each MFE. The classic approach requires hard-coded prerequisites in a core shell application, even when dynamic module loading is used. In such conventional approaches, a strict coordination between the core shell application and every MFE is mandatory.

Illustrative embodiments provide technical solutions for implementing a MFE auto-configurator, which includes an API for a generic MFE configuration, a controller which processes distributed MFE configurations and generates a single unified MFE configuration, and a utilization mechanism to consume the data by the core shell application. The technical solutions provide a generic approach, as well as a Kubernetes (K8S) implementation for a dynamic injection of distributed MFEs into a unified ecosystem (e.g., a core shell composite application) while avoiding hard-coded paths, JavaScript bundle names, activation configuration, navigation items, layout configuration, etc.

The technical solutions described herein in some embodiments provide a distributed auto-configuration for frontend microservices through auto-merging of different distributed frontend microservice configurations (e.g., MFE configurations), including monitoring for configuration changes and performing dynamic reconciliation. In addition, the technical solutions described herein in some embodiments enable auto-updating of an entire GUI of a composite application according to modified configurations. The technical solutions described herein provide a novel and innovative process for frontend configuration in MFE environments. The technical solutions described herein further provide a novel and innovative usage of a “zero-knowledge” pattern in the MFE main or core shell application while delegating the responsibility of MFE onboarding to itself, ensuring that setting up of the MFE is done only by the MFE itself (e.g., self-onboarding) while keeping the core shell application intact.

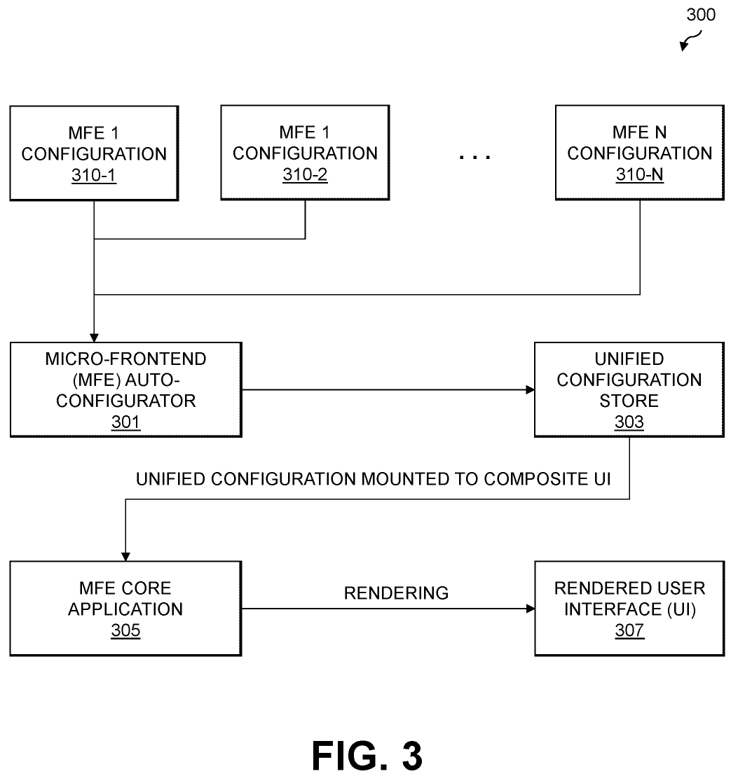

FIG. 3 shows a system 300 implementing a MFE auto-configurator 301. The MFE auto-configurator 301 provides an API which is configured to receive MFE configurations 310-1, 310-2, . . . 310-N (collectively, MFE configurations 310) associated with different MFEs. The MFE auto-configurator 301 analyzes and merges the MFE configurations 310 and stores them in a unified configuration store 303. The unified MFE configuration maintained in the unified configuration store 303 is mounted to a composite UI of MFE core application 305, which is rendered to provide a rendered UI 307.

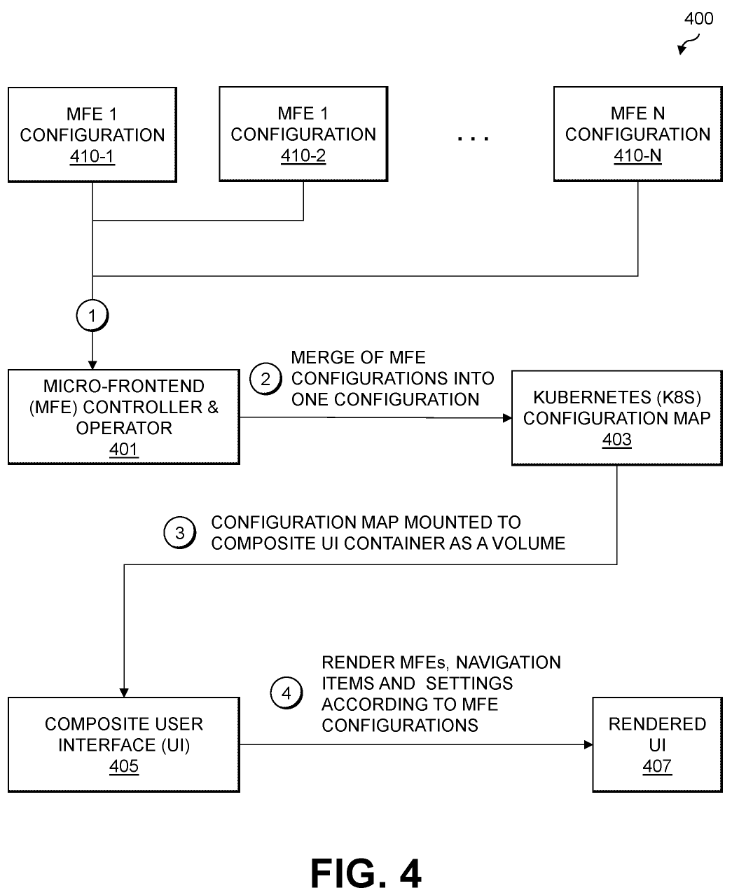

FIG. 4 shows a system 400 implementing a Kubernetes implementation based on a Kubernetes Operator including a controller (e.g., MFE controller and operator 401), Custom Resource Definition (CRD) MFE configurations (e.g., MFE configurations 410-1, 410-2, . . .410-N, collectively MFE configurations 410), and a configuration map (e.g., K8S configuration map 403). The MFE controller and operator 401 obtains MFE configurations 410 (e.g., CRD MFE configurations ), and merges the MFE configurations 410 into one unified MFE configuration which is stored as the K8S configuration map 403 (e.g., a configuration map or ConfigMap resource). The configuration map is mounted to a composite UI 405 as a volume, and the composite UI 405 renders the MFEs, navigation items and settings according to the MFE configurations 410 to provide the rendered UI 407.

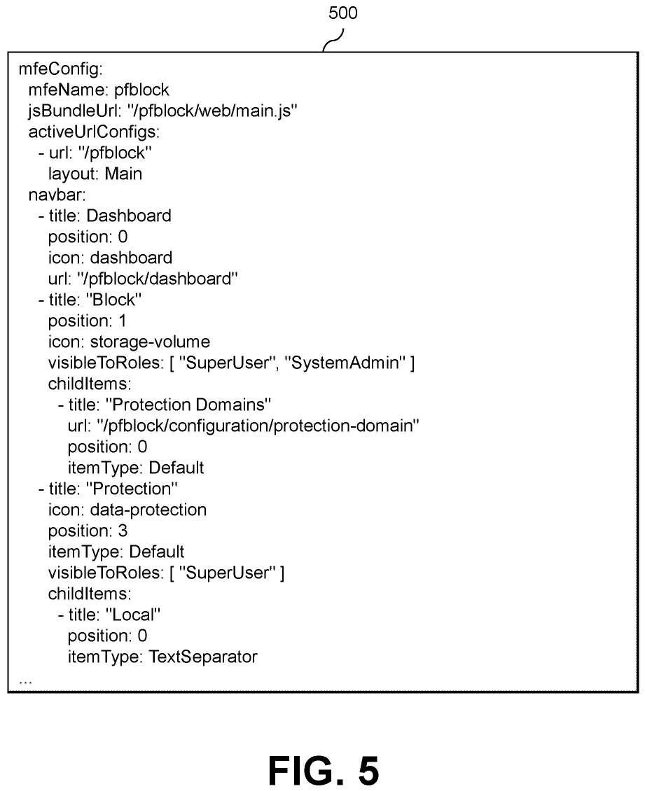

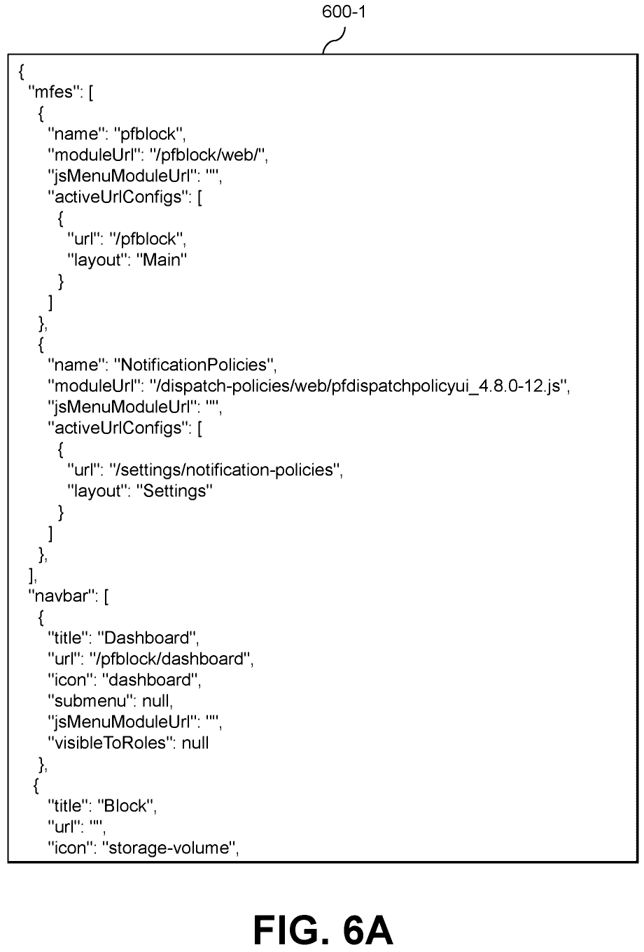

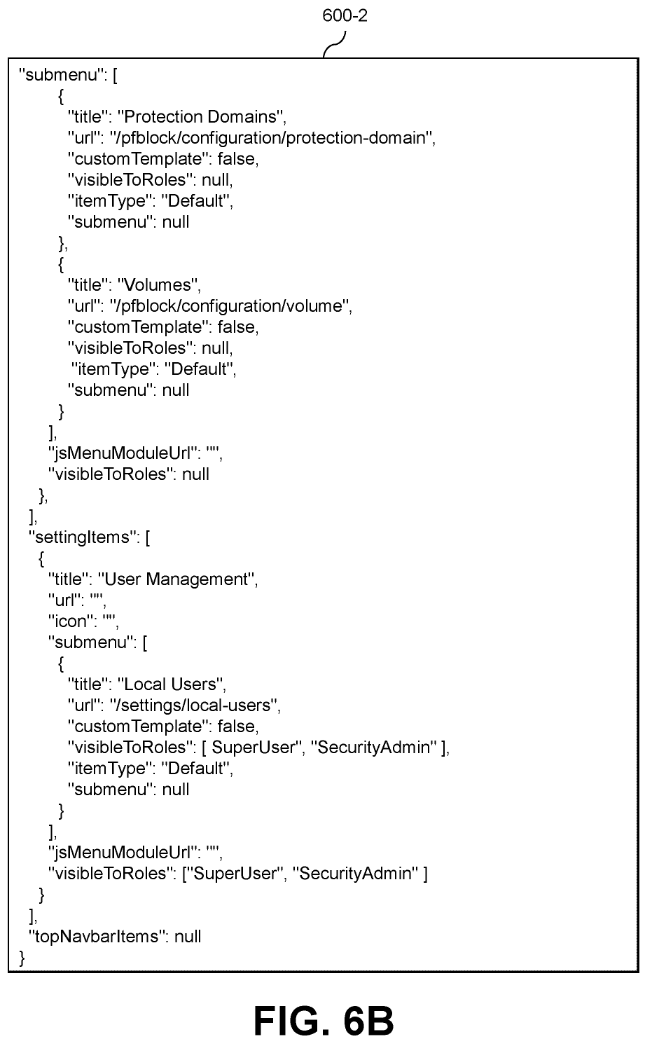

The CRD MFE configurations contain the complete details about MFE configurations, including a name, a JavaScript bundle filename and its location, MFE activation conditions, layout configuration, navigation menu items, settings page configuration, etc. FIG. 5 shows pseudocode 500 of an example MFE configuration file for an MFE with the name “pfblock.” The MFE configuration file, also referred to as an MFEConfig, is framework agnostic and can be used with various different web application frameworks such as ReactJS, Angular, AngularJS and pure JS. Each MFE has its own configuration, which is an integral part of the MFE itself, and is usually, but not necessarily, committed into an MFE repository. The MFE controller and operator 401 orchestrates and merges multiple configurations from different MFEs (e.g., the MFE configurations 410) into a single ConfigMap resource (e.g., the K8S configuration map 403). The MFE controller and operator 401 continually monitors the MFE configurations 410 and reconciles any changes and updates the resulting ConfigMag resource accordingly. Thus, the MFE controller and operator 401 provides dynamic onboarding and offboarding of MFEs in runtime. Consequently, the ConfigMap resource includes all the configuration needed for the composite UI 405. FIGS. 6A and 6B show pseudocode portions 600-1 and 600-2 (collectively, pseudocode 600) of a portion of a ConfigMap resource for multiple MFEs (e.g., including the “pfblock” MFE with the MFE configuration illustrated in FIG. 5 and another MFE with the name “NotificationPolicies”). The portion or snippet of the ConfigMap resource shown in FIG. 6 includes the two MFEs (e.g., pfblock and NotificationPolicies) along with main navigation configuration and settings.

The configuration mapping produced by the MFE controller and operator 401 (e.g., the ConfigMap resource maintained as K8S configuration map 403) is mounted to the composite UI 405 as a file and is available via an HTTP request. The composite UI 405 consumes the configuration, parses it, spins or renders the MFE in its proper layout, activates the MFEs according to their activation conditions, and renders the relevant menus and settings accordingly in the rendered UI 407. The MFEs themselves are framework-agnostic.

The overall process flow in system 400 includes:
1. MFE controller and operator 401 receives MFE configurations 410 from MFEs. Each MFE has its own MFE configuration (e.g., a YAML file, providing a newly-introduced CRD), which creates a MFE configuration resource in a Kubernetes environment.
2. The MFE controller and operator 401 constantly monitors the Kubernetes environment for all MFE configurations 410, and merges separate MFE configurations into one configuration structure (e.g., resolving conflicts, providing proper navigation item grouping and sorting, etc.). The unified configuration structure is published as a ConfigMap resource (e.g., in JavaScript Object Notation (JSON) format) as the K83 configuration map 403.
3. The composite UI 405 container consumes the unified configuration by mounting the ConfigMap resource as a volume.
4. The composite UI 405 utilizes the provided information (e.g., locations of MFE JavaScript bundles, navigation and settings configurations, etc.) for rendering the GUI as rendered UI 407.

Conventional approaches that allow for onboarding MFEs into a core shell application in runtime focus on a dynamic onboarding of a MFE JavaScript bundle only. The technical solutions described herein provide a complete mechanism for the dynamic configuration of multiple MFEs, including source location, activation conditions, navigation and settings pages, etc. Conventional approaches require the core shell application to recognize initial MFE metadata prior to runtime, whereas the technical solutions described herein allow for self-onboarding and self-offboarding MFEs, keeping a zero-knowledge approach in the core shell application. Further, conventional approaches are limited to usage of a single JavaScript framework (e.g., ReactJS or Angular) across an entire application. This narrows the distributed MFE environment to use a single framework, and reduces a benefit of the frontend microservices system architecture (e.g., enabling independently deployable frontend modules with their own independent CI build pipelines that may use different frameworks). Further, conventional approaches that require use of a single framework make it impossible to utilize an existing solution for legacy projects. The technical solutions described herein are advantageously fully framework-agnostic, are adoptable for any framework, and work seamlessly in multi-framework ecosystems (e.g., including, but not limited to, legacy Angular, AngularJS and ReactJS frameworks).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for merging configurations of frontend microservices defining portions of a UI of a web application will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705 and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for merging configurations of frontend microservices defining portions of a UI of a web application as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine configuration information for two or more frontend microservices, the two or more frontend microservices defining two or more different portions of a user interface of a web application;
to generate a merged configuration, the merged configuration comprising a configuration map merging the configuration information for the two or more frontend microservices; and
to provide the merged configuration for the two or more frontend microservices for mounting in a core shell of the web application running on a client device for rendering of the two or more different portions of the user interface of the web application.

2. The apparatus of claim 1 wherein the two or more frontend microservices comprise independently deployable micro-frontends for the user interface of the web application.

3. The apparatus of claim 1 wherein the configuration information for a given one of the two or more frontend microservices specifies one or more activation conditions for rendering a given portion of the user interface of the web application.

4. The apparatus of claim 1 wherein the configuration information for a given one of the two or more frontend microservices specifies a layout configuration for rendering a given portion of the user interface of the web application.

5. The apparatus of claim 1 wherein the configuration information for a given one of the two or more frontend microservices specifies at least one of navigation menu items and settings page configurations for rendering a given portion of the user interface of the web application.

6. The apparatus of claim 1 wherein generating the merged configuration comprises at least one of grouping and sorting of navigation items of the two or more different portions of the user interface of the web application.

7. The apparatus of claim 1 wherein generating the merged configuration comprises resolving one or more conflicts between a first portion of the configuration information for a first one of the two or more frontend microservices and at least a second portion of the configuration information for a second one of the two or more frontend microservices.

8. The apparatus of claim 1 wherein the merged configuration specifies locations of code bundles for the two or more frontend microservices.

9. The apparatus of claim 1 wherein a first one of the two or more frontend microservices utilizes a first web application framework and at least a second one of the two or more frontend microservices utilizes a second web application framework, the second web application framework being different than the first web application framework.

10. The apparatus of claim 1 wherein providing the merged configuration for the two or more frontend microservices for mounting in the core shell of the web application running on the client device comprises providing the merged configuration for mounting to a designated hard-coded prerequisite in the core shell of the web application.

11. The apparatus of claim 1 wherein providing the merged configuration for the two or more frontend microservices for mounting in the core shell of the web application running on the client device comprises providing the merged configuration as a volume for mounting in the core shell of the web application.

12. The apparatus of claim 1 wherein the at least one processing device is further configured:
to monitor for one or more changes in the configuration information for the two or more frontend microservices;
to dynamically update the merged configuration for the two or more frontend microservices based at least in part on the monitored one or more changes in the configuration information for the two or more frontend microservices; and
to provide the dynamically updated merged configuration for the two or more frontend microservices to the core shell of the web application running on the client device for real-time updating of the rendering of the two or more different portions of the user interface of the web application.

13. The apparatus of claim 12 wherein the one or more changes in the configuration information for the two or more frontend microservices comprises real-time onboarding one or more additional frontend microservices.

14. The apparatus of claim 12 wherein the one or more changes in the configuration information for the two or more frontend microservices comprises real-time offboarding of at least one of the two or more frontend microservices.

15. A computer program product comprising a non-transitory processor-readable storage medium having stored therein program code of one or more software programs, wherein the program code when executed by at least one processing device causes the at least one processing device:
to determine configuration information for two or more frontend microservices, the two or more frontend microservices defining two or more different portions of a user interface of a web application;
to generate a merged configuration, the merged configuration comprising a configuration map merging the configuration information for the two or more frontend microservices; and
to provide the merged configuration for the two or more frontend microservices for mounting in a core shell of the web application running on a client device for rendering of the two or more different portions of the user interface of the web application.

16. The computer program product of claim 15 wherein generating the merged configuration comprises resolving one or more conflicts between a first portion of the configuration information for a first one of the two or more frontend microservices and at least a second portion of the configuration information for a second one of the two or more frontend microservices.

17. The computer program product of claim 15 wherein the program code when executed by the at least one processing device further causes the at least one processing device:
to monitor for one or more changes in the configuration information for the two or more frontend microservices;
to dynamically update the merged configuration for the two or more frontend microservices based at least in part on the monitored one or more changes in the configuration information for the two or more frontend microservices; and
to provide the dynamically updated merged configuration for the two or more frontend microservices to the core shell of the web application running on the client device for real-time updating of the rendering of the two or more different portions of the user interface of the web application.

18. A method comprising:
determining configuration information for two or more frontend microservices, the two or more frontend microservices defining two or more different portions of a user interface of a web application;
generating a merged configuration, the merged configuration comprising a configuration map merging the configuration information for the two or more frontend microservices; and
providing the merged configuration for the two or more frontend microservices for mounting in a core shell of the web application running on a client device for rendering of the two or more different portions of the user interface of the web application;
wherein the method is performed by at least one processing device comprising a processor coupled to a memory.

19. The method of claim 18 wherein generating the merged configuration comprises resolving one or more conflicts between a first portion of the configuration information for a first one of the two or more frontend microservices and at least a second portion of the configuration information for a second one of the two or more frontend microservices.

20. The method of claim 18 further comprising:
monitoring for one or more changes in the configuration information for the two or more frontend microservices;
dynamically updating the merged configuration for the two or more frontend microservices based at least in part on the monitored one or more changes in the configuration information for the two or more frontend microservices; and
providing the dynamically updated merged configuration for the two or more frontend microservices to the core shell of the web application running on the client device for real-time updating of the rendering of the two or more different portions of the user interface of the web application.
